(19) United States
(12) Patent Application Publication
(10) Pub. No.: US 2017/0326553 A1
(43) Pub. Date: Nov. 16, 2017

(54) VACUUM GRINDING SYSTEM AND METHOD

(71) Applicant: FREWITT FABRIQUE DE MACHINES SA, Granges-Paccot (CH)

(72) Inventors: Antoine VIRDIS, Ferpicloz (CH); Christophe PASQUIER, Romanens (CH)

(21) Appl. No.: 15/533,682

(22) PCT Filed: Dec. 7, 2015
(86) PCT No.: PCT/IB2015/059414

§ 371 Date: Jun. 7, 2017

(30) Foreign Application Priority Data
Dec. 9, 2014 (CH) 01898/14

(51) Int. Cl. B02C 13/286; B02C 25/00; B02C 13/288

(52) U.S. Cl. CPC B02C 13/286; B02C 25/00; B02C 13/288; B02C 2013/28618; B02C 2013/28609

(57) ABSTRACT

A vacuum grinding system having multiple elements connected in series. The elements include an input chamber next to the system input, which chamber can be fluidically connected to a vacuum pump; a grinding chamber which is arranged downstream of the input chamber and which can be fluidically connected to a vacuum pump; and an output chamber, downstream of the grinding chamber and next to the output system, which output chamber can also be fluidically connected to a vacuum pump.

### TECHNICAL FIELD

The present invention relates to an in-line vacuum grinding system comprising a plurality of elements connected in series, of which an inlet chamber adjacent to the inlet of the system, a grinding chamber arranged downstream of the inlet chamber, and an outlet chamber, downstream of the grinding chamber, each element being capable of being connected in fluid connection to a vacuum pump. The invention also relates to the corresponding grinding method.

The invention relates more particularly to a vacuum grinding system and method suitable for powder transformation processes.

### STATE OF THE ART

Patent application WO 08/001854 proposes a grinding device having an improved grinding efficiency achieved by the reduction of the air current caused by the rotation of the rolling bodies. The device crushes objects by compressing them with the rolling bodies, and in the device, a vacuum pump is connected over a grinding space for crushing the objects, the objects being ground in a vacuum environment.

Document JP 6198211 discloses a crusher using a vacuum pump to perform vacuum grinding. The vacuum pump is connected to the main body in order to carry out the grinding. A filter bag for separating air and fine particles is not required. When the air is properly evacuated, a raw material is finely ground as a whole.

Document FR 2628007 relates to a vacuum percussion crusher. The crusher comprises a tank defining a chamber with a reduced pressure provided with a linking connector with suction means, a vertical axis wheel for spraying the material at high speed by centrifugal force placed in the chamber and provided with a rotary driving motor, with a device for supplying the chamber with fragments of the material to be ground, opening out above the wheel, a target intended to receive the impact of the fragments of the material and means for evacuating the ground material collected at the bottom of the enclosure. The target consists of fragments of the material to be ground. The grinder is particularly suitable for processing low-grade ores.

Document EP0218790 relates to a method and device for continuous vacuum grinding. It comprises at least one body that can be displaced to form a chamber inside said pumping means which can be closed to the ambient air, means for filling the meat chamber, mechanical means for closing the meat-filled chamber to the ambient air and for isolating said chamber from said grinding plate, and means for removing entrapped air within the closed chamber filled with meat.

All these devices allow either continuous or high vacuum grinding, however, none of them allows the two to be cumulated. Vacuuming is a prerequisite for ensuring the quality of the grinding, for respecting the integrity of the material to be ground, in particular in the food and pharmaceutical field. The vacuum conditions established in the aforementioned devices, insofar as there is never any cumulating of continuous and high vacuum, lead to a (limited but effective) oxidation of the material to be ground and therefore to an alteration of its essential qualities.

To overcome these various disadvantages, the invention provides various technical means.

### BRIEF SUMMARY OF THE INVENTION

A first object of the invention is to provide a grinding system in which the materials to be ground are placed under continuous high vacuum conditions throughout the duration of the grinding operation.

Another object of the invention is to provide a continuous and high vacuum grinding system, i.e. a vacuum such that the oxygen concentration is equal to or less than 10%, for example between 1% and 10%.

To do this, the invention provides a vacuum (in-line) grinding system comprising a plurality of elements connected in series, said elements comprising:

an inlet chamber adjacent to the inlet of the system, capable of being connected in fluid connection to a vacuum pump;

a grinding chamber, arranged downstream of the inlet chamber, capable of being connected in fluid connection to a vacuum pump; and

an outlet chamber, downstream of the grinding chamber and adjacent to the outlet of the system, also capable of being connected in fluid connection to a vacuum pump.

According to such an architecture in series, the grinder allows grinding under high and continuous vacuum conditions thanks to a leak-tight separation of the various chambers and a connection to the vacuum pump possible in several places, thus at different stages of the grinding procedure. The quality of the raw material is thus preserved. The grinding system of the invention also ensures respect for the integrity of persons (operators) and equipment in the case of explosive products. Indeed, vacuum grinding makes it possible to grind potentially explosive products with much less risk than when these products are ground in the presence of oxygen. In this case, the use of inert gases is not necessary. The grinding system of the invention also makes it possible to minimize the heating during grinding and also allows a reduction in noise, in comparison with conventional grinding carried out under normal atmospheric conditions.

According to an advantageous embodiment, the inlet chamber can be isolated either from the inlet of the system or from the grinding chamber or from both simultaneously. The grinding chamber can itself be isolated either from the inlet chamber or from the outlet chamber or from both simultaneously. The outlet chamber, on the other hand, can be isolated either from the grinding chamber or from the outlet of the system, or from both simultaneously.

According to another advantageous embodiment, the vacuum grinding system comprises a grinding chamber which comprises a grinder.

According to another advantageous embodiment, the grinding system comprises a plurality of material flow control valves arranged between each of the chambers, between the inlet of the system and the inlet chamber, between the outlet chamber and the outlet of the system.

Advantageously, each of the chambers has an extraction outlet for fluid connection to a vacuum pump.

Also advantageously, the extraction outlets are provided with vacuum pumping control valves.

According to yet another embodiment, the input chamber or the grinding chamber comprises a metering device for the quantity of material to be ground.

The invention further provides a vacuum grinding method for the vacuum grinding system comprising the steps of:

opening the inlet material flow control valve to proceed with admitting the material to be ground into the inlet chamber;

after admission of the material to be ground into the inlet chamber, closing the inlet flow control valve;

(opening of the inlet chamber extraction valve) establishing a fluid connection between the inlet chamber and a vacuum pump and evacuating the inlet chamber;

opening the pre-grinding flow control valve to supply the grinding chamber with material to be ground;

after admission of the material to be ground into the grinding chamber, closing the grinding flow control valve;

grinding the material using the grinder;

opening the post-grinding flow control valve to ensure that the ground material passes into the outlet chamber;

closing the post-grinding flow control valve;

reducing or stopping the air-evacuation of the outlet chamber;

waiting for the pressure at the outlet chamber to reach a predetermined output threshold; and

opening the outlet flow control valve to carry out the passage of the ground material from the outlet chamber to the outlet of the grinding system.

According to yet another variant embodiment, the grinding process comprises a prior step consisting in closing all the material flow valves and performing at least partial evacuation of each of the chambers of the grinding system before initiating the step of opening the flow control valve.

According to yet another variant embodiment, the grinding step is preceded by a step of metering the quantity of material to be admitted to the grinder.

### BRIEF DESCRIPTION OF THE DRAWINGS

Examples of embodiments of the invention are indicated in the description illustrated by the attached figures in which:

FIG. 1 is a schematic view of the device as a whole according to the invention;

FIG. 2 is a flow chart showing the various steps of the grinding process;

FIG. 3 comprises a general sequence of operation of the grinding system, according to one embodiment;

FIG. 4 shows a sequence of the steps of letting the material into the grinding chamber, according to one embodiment;

FIG. 5 shows the sequence of grinding steps, according to one embodiment; and

FIG. 6 shows the sequence of steps after the grinding steps, according to one embodiment.

### EXAMPLE(S) OF EMBODIMENTS OF THE INVENTION

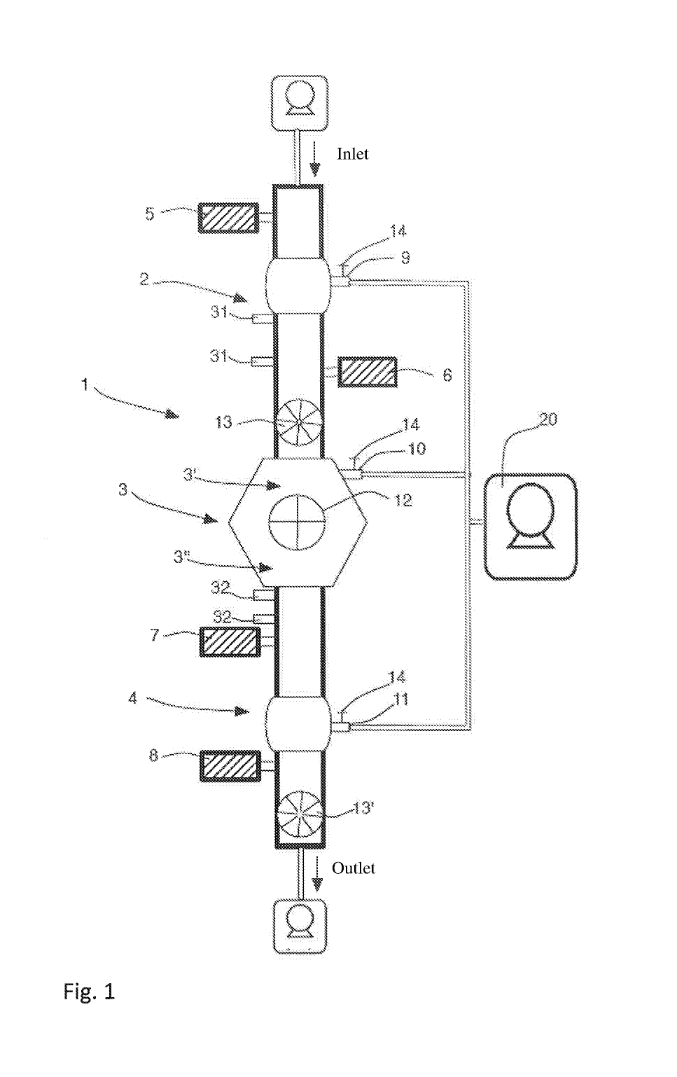

FIG. 1 illustrates an embodiment in which the grinding system is shown schematically. The inlet chamber 2 is provided with a leak-tight material flow control valve 5, ensuring perfectly hermetic isolation of said chamber from the inlet of the system.

This chamber can also be connected to a vacuum pump 20 via an extraction outlet 9, which makes it possible to place the chamber in question under vacuum. The grinding chamber 3 comprises a grinder 12. It is also provided with an extraction outlet 10 for fluid connection to a vacuum pump 20 and a leak-tight grinding flow control valve 6 making it possible to place said grinding chamber under vacuum at a substantially similar pressure to that of the chamber 2, thus guaranteeing that the material to be ground is maintained in continuous high vacuum conditions when it passes from one chamber to the other. The extraction outlet 10 is actuated by a valve actuator 14 based on an actuation of the pneumatic, electric, manual or other type. A flow regulator (or doser) 13 makes it possible to control the quantity of material transmitted to the grinding chamber. The flow regulator 13 also makes it possible to fluidize the material to be ground and therefore to fluidize the flow of the material to be ground entering the grinding chamber 3.

It is thus possible to ensure that only a reasonable quantity of material is transmitted to the grinder, thus guaranteeing quality grinding and avoiding any obstruction of the grinder 12. The outlet chamber 4 is provided with two material flow control valves, one upstream 7 and the other downstream 8, as well as an extraction outlet 11 for fluid connection with a vacuum pump 20 for receiving the ground material under vacuum conditions similar to those of the grinding chamber 3, thus ensuring the continuity of the high vacuum in the system. The extraction outlet 11 can also be actuated by a valve actuator 14.

This system also makes it possible to reduce the air evacuation of said outlet chamber 4 in order to reach a predetermined threshold adapted to the output of the ground material of the system, which output can be controlled by means of the outflow control valve 8.

In one embodiment, the high vacuum corresponds to a vacuum resulting in an oxygen concentration which is equal to or less than 10%, for example between 1% and 10%. In relation to the sea level, where the atmosphere is composed of 20.8% oxygen at an absolute pressure of 1.013 bar, a value of 7% or less is to be reached (corresponding to a pressure lower than or equal to 0.34 bar absolute). The measurement of the oxygen content can be carried out by means of a measurement of the pressure (or of the vacuum) in each of the chambers for inlet 2, grinding 3 and outlet 4. The pressure measurement is directly related to the oxygen concentration in the chamber 2, 3, 4 and allows a shorter response time for the oxygen percentage measurement, for example, than a measurement of the oxygen concentration based on a chemical reaction.

In a variant, the vacuum grinding system 1 comprises a second flow regulator 13′ placed in or after the outlet chamber 4 and making it possible to control the quantity of ground material leaving the outlet chamber 4. The second flow regulator 13′ can also be connected to the outlet flow control valve 8 so as to meter determined quantities of ground material. In yet another variant, the second flow regulator 13′ and/or the outlet flow control valve 8 may be connected to a balance (not shown) so as to meter the ground material according to set-point weight values.

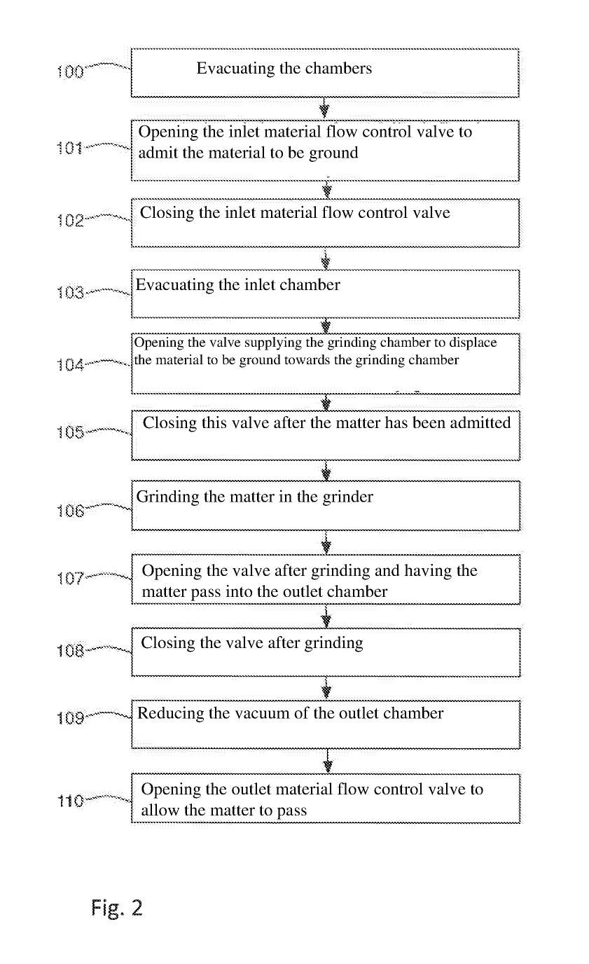

FIG. 2 illustrates the main steps of a grinding process for a vacuum grinding system 1 according to the invention. In step 100, the various chambers 2, 3, 4 of the system are evacuated.

In step 101, the inlet material flow control valve 5 is opened to accommodate the material to be ground in the inlet chamber 2. Step 102 consists in closing the inlet material flow control valve 5 upon admission of the material into the inlet chamber 2.

In step 103, air is evacuated from the inlet chamber 2. This evacuation makes it possible to remove the air that came in at the time of admission of the material to be ground into the inlet chamber 2. This phase is important to ensure that the vacuum of the grinding chamber 3 is not affected.

In step 104, the opening of the valve 6 feeding the grinding chamber 3 takes place in order to allow the material to be ground to be transferred from the inlet chamber 2 to the grinder 12. Step 105 relates to the closing of said valve 6 feeding the grinding chamber 3 after passage of the material.

In step 106, the grinding of the material takes place in the grinder 12. Step 107 consists in opening the post-grinding valve 7 in order to allow the ground material to pass from the grinding chamber 3 into the outlet chamber 4.

The step 108 consists in closing the post-grinding valve 7. At step 109, there is a reduction in the evacuation of the outlet chamber 4 to prevent a pressure differential from perturbing the flow of material from the outlet chamber 4 to the outlet of the system, or to prevent a backflow from occurring.

Finally, step 110 is characterized by opening the outlet flow valve 8 to allow the ground material resulting from the process to exit.

During the opening of the valve 6 feeding the grinding chamber 3 (step 4), the material to be ground is transmitted from the inlet chamber 2 to the inlet 3′ of the grinding chamber 3. During the grinding step (step 106), the material is ground in the grinder 12 and the ground material flows to the outlet 3″ of the grinding chamber 3.

The steps 100 to 110 of the grinding process can be repeated so as to provide continuous grinding material.

According to one embodiment, the grinding process comprises repeating the steps of:

opening the inlet material flow control valve 5 in order to receive material to be ground in the inlet chamber 2 (step 101);

closing the inlet material flow control valve 5 after the material has been admitted into the inlet chamber 2 (step 102);

evacuating the air from the inlet chamber 2 (step 103);

opening the valve 6 feeding the grinding chamber 3 (step 104);

and closing said valve 6 (step 105);

before the material to be ground previously introduced into the grinding chamber 3 has been completely ground (step 106).

In this embodiment, new material to be ground is therefore transmitted from the inlet chamber 2 to the grinding chamber 3 before the material to be ground previously introduced into the grinding chamber 3 has been completely ground. The inlet chamber 2 (i.e. the volume comprised between the inlet material flow control valve 5 and the valve 6 feeding the grinding chamber) then serves as a buffer zone for the new material that is to be received in the grinding chamber 3. The output 3″ (i.e. the volume between the grinder 12 and the post-grinding flow control valve 7) also serves as a buffer zone for the ground material.

The material flow and the grinding flow (or grinding speed) and the amount of material to be ground that is received in the inlet chamber 2 can be adjusted so that the grinding process operates continuously, i.e. the vacuum grinding system 1 can supply grinder material continuously.

The figures and their descriptions given above illustrate the invention rather than limit it. In particular, the invention and its various variants have just been described in connection with a particular example comprising a grinding system substantially in line.

Nevertheless, it is obvious to a person skilled in the art that the invention can be extended to other embodiments in which, in variants, a grinding system in the form of a “U”, “L” etc. is provided.

In a variant, the grinding system 1 comprises two grinding chambers 3 in series, in order to ensure a substantially constant and durable quality.

Still in one embodiment, the grinding system 1 comprises one or several level-sensors, whose purpose is to indicate the presence or not of the material to be ground or of the ground material in one of the chambers 2, 3, 4. To this end, the sensor may be a radar, ultrasonic, capacitive or radiometric level-sensor.

In one configuration of the grinding system 1, a first level-sensor 31 is included between the inlet chamber 2 and the grinding chamber 3 and a second level-sensor 32 is included between the grinding chamber 3 and the outlet chamber 4. The signaling coming from the first level-sensor 31 will cause the fluid connection to be established between the inlet chamber 2 and the grinding chamber 3 (by activating the valve 6 feeding the grinding chamber), in the absence of material. In the presence of material, the signaling coming from the first level-sensor 31 will cause the fluid connection between the inlet chamber 2 and the grinding chamber 3 to be interrupted (by stopping the valve 6 feeding the grinding chamber). Similarly, the signaling coming from the second level-sensor 32 will cause the fluid connection between the grinding chamber 3 and the chamber 4 to be established (by activating the post-grinding flow control valve 7) and the interruption of the fluid connection between the grinding chamber 3 and the chamber 4 (by stopping the post-grinding flow control valve 7), respectively in the absence and in the presence of material. In this way, the grinding system 1 can be completely automated.

In a preferred configuration, the first level-sensor comprises a sensor 31 at the top and at the bottom of the accumulation zone between the inlet chamber 2 and the grinding chamber 3. The second level-sensor comprises a sensor 32 at the top and at the bottom of the accumulation zone between the grinding chamber 3 and the outlet chamber 4. For example, the first sensor 31 may be placed at the outlet of the inlet chamber 2 (downwardly in FIG. 1) after the grinding flow control valve 6 and at the inlet of the grinding chamber 3, before the flow regulator 13. The second sensor 32 can be placed at the outlet of the grinding chamber 3 and at the inlet of the outlet chamber 4 before the post-grinding flow control valve 7.

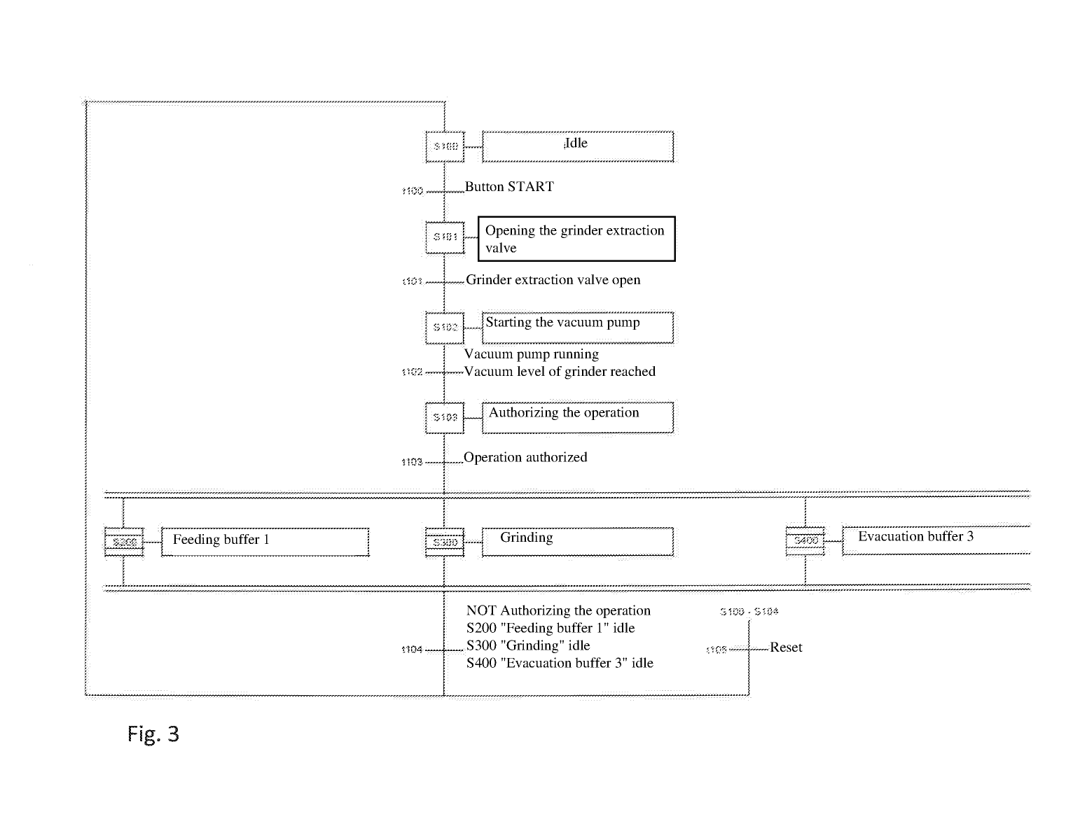

FIGS. 3 to 6 show algorithms comprising sequences of automatic operating steps of the grinding system 1 according to one embodiment. In particular, FIG. 3 comprises a general sequence of operation of the grinding system 1. The initially idle grinding system (S100) is started by opening the valve feeding the grinding chamber 6 (grinder extraction valve, S101), followed by starting the vacuum pump 20 (S102) and by authorizing the operation (S103).

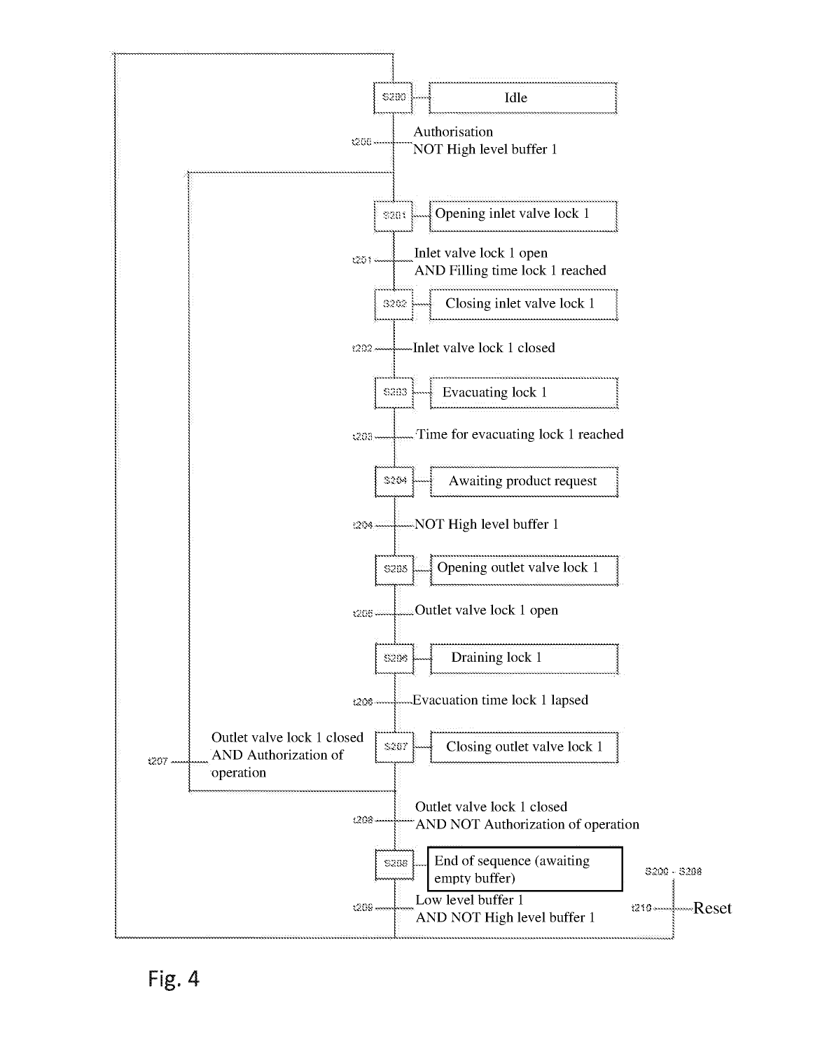

FIG. 4 shows the sequence of steps from the material entry into the grinding chamber. That is, after resting (S200), the steps comprising opening the inlet material flow control valve (inlet valve lock 1, S201) and closing it (S202) after filling the material in the inlet chamber 2; the air evacuation of the inlet chamber 2 (evacuation lock 1, S203); the opening of the valve supplying the grinding chamber 6 (outlet valve 1 lock, S205) after a certain period of time (awaiting product request, S204) emptying the inlet chamber 2 of the material (drain valve lock 1, S206); and closing the valve feeding the grinding chamber 6 (outlet valve lock 1, S207). Step S208 corresponds to the end of this sequence, once the inlet chamber 2 is empty of material.

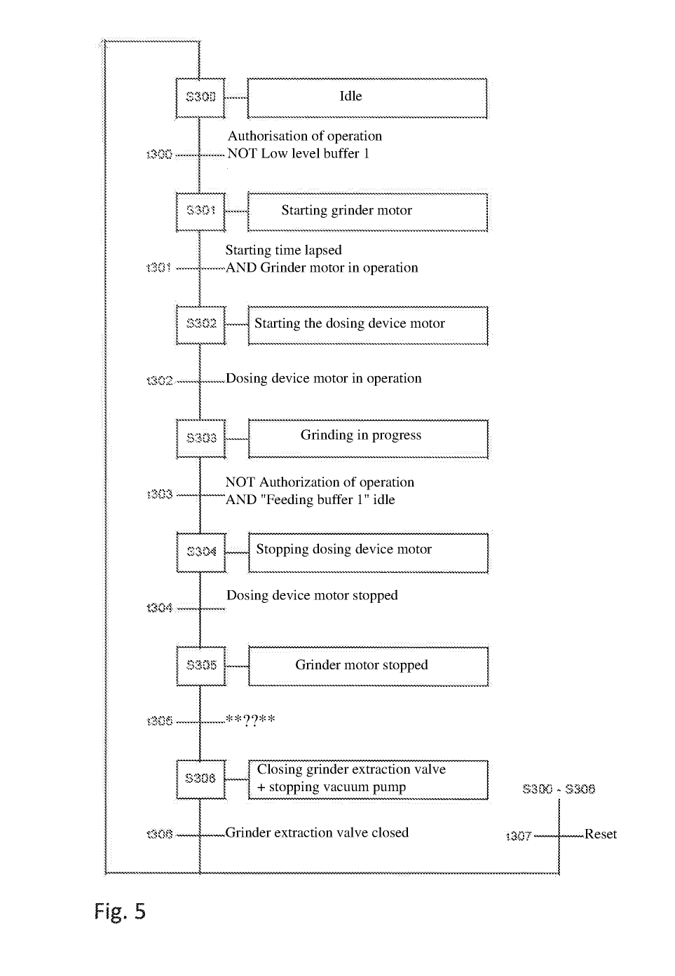

FIG. 5 shows the sequence of grinding steps and, in particular: starting the grinder (starting the grinder motor, S301) after the resting step (S300); starting the dosing device 13 (S302); grinding step (S303); stopping the dosing device 13 (S304); stopping the grinder (S305); and closing the post-grinding flow control valve 7 (grinder outlet valve) and stopping the vacuum pump 20 (S306).

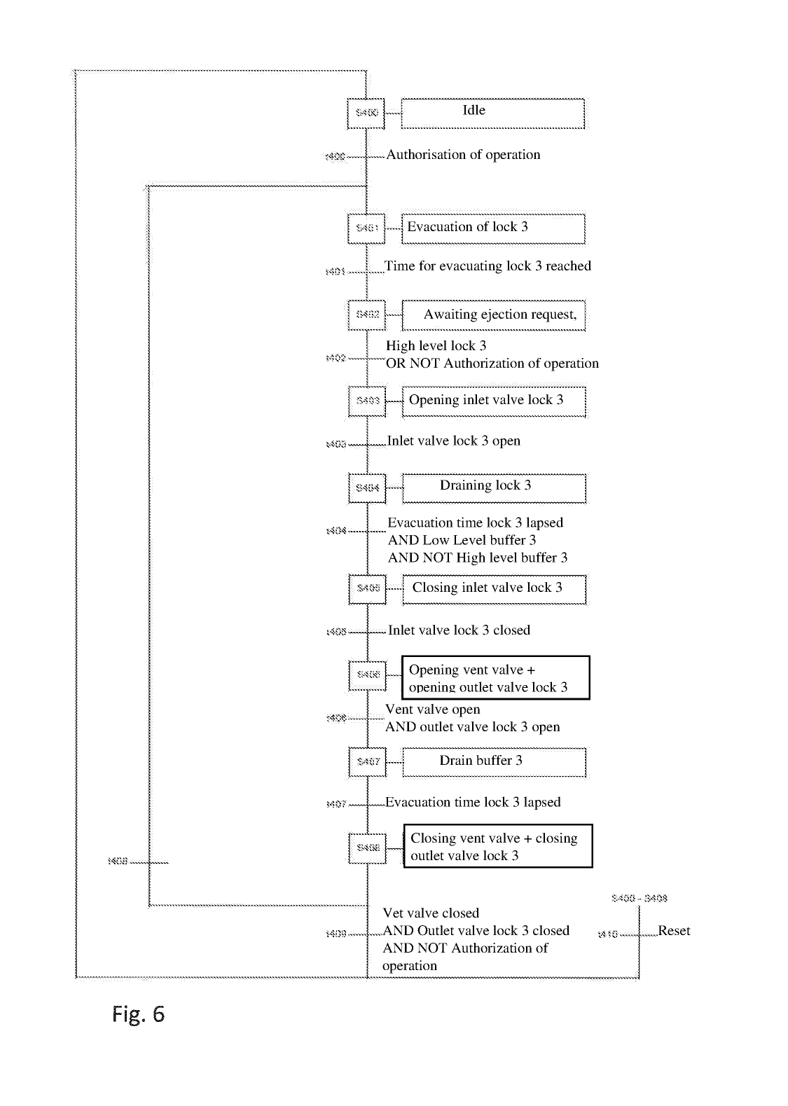

FIG. 6 shows the sequence of the following steps, after the resting (S400): evacuating the outlet chamber 4 (evacuation of the lock 3, S401); a step of waiting before the ground material exits from the grinding chamber 3 (awaiting ejection request, S402); opening the post-grinding flow control valve 7 (inlet valve lock 3, S403); extracting the ground material from the grinding chamber 3 (draining lock 3, S405); opening the outlet flow control valve 8 (opening valve outlet lock 3, S406); extracting the ground material from the outlet chamber 4 (buffer drain 3, S407); and closing the outlet flow control valve 8 (closing outlet valve lock 3, S408).

The references in the claims are not limiting. The verbs “to comprise” and “to include” do not exclude the presence of elements other than those listed in the claims. The word “one”/“a(n)” preceding an element does not exclude the presence of a plurality of such elements.

### REFERENCE NUMBERS USED IN THE FIGURES

1 Vacuum grinding system
2 Inlet chamber
3 Grinding chamber
3′ Inlet of the grinding chamber
3″ Outlet of the grinding chamber
4 Outlet chamber
5 Flow control valve for input material
6 Valve feeding the grinding chamber
7 Post-grinding flow control valve
8 Outlet flow control valve
9, 10, 11 Extraction outlet
12 Grinder
13 Flow regulator, doser
13′ Second flow regulator, second doser
14 Actuator of the valve
20 Vacuum pump
31 First level-sensor
32 Second level-sensor

What is claimed is:

1. Vacuum grinding system having a plurality of elements connected in series, said elements comprising:
an inlet chamber adjacent to the inlet of the system, capable of being connected in fluid connection to a vacuum pump;
a grinding chamber, arranged downstream of the inlet chamber, capable of being connected in fluid connection to a vacuum pump; and
an outlet chamber, downstream of the grinding chamber and adjacent to the outlet of the system, also capable of being connected in fluid connection to a vacuum pump.

2. A vacuum grinding system according to claim 1, wherein:
the inlet chamber is capable of being isolated either from the inlet of the system or from the grinding chamber or from both simultaneously;
the grinding chamber can be isolated either from the inlet chamber or from the outlet chamber or from both simultaneously;
the outlet chamber can be isolated either from the grinding chamber or from the outlet of the system, or from both simultaneously.

3. Vacuum grinding system according to claim 1, wherein the grinding chamber comprises a grinder.

4. Grinding system according to claim 1, comprising a plurality of material flow control valves arranged between each of the chambers, between the inlet of the system and the inlet chamber, between the outlet chamber and the outlet of the system.

5. Grinding system according to claim 1, wherein each of the chambers has an extraction outlet for fluid connection to a vacuum pump.

6. Grinding system according to claim 1, in which the extraction outlets are provided with vacuum pumping control valves.

7. Grinding system according to claim 1, in which the input chamber or the grinding chamber has a flow regulator for the quantity of material to be ground.

8. Grinding system according to claim 1, further comprising a second flow regulator for controlling the amount of ground material exiting the outlet chamber.

9. Grinding system according to claim 4 and further comprising a second flow regulator for controlling the amount of ground material exiting the outlet chamber, wherein the second flow regulator is connected to the outlet flow control valve so as to meter determined quantities of ground material.

10. Grinding system according to claim 1, comprising at least one level-sensor which is configured to measure and signal the presence or absence of the material to be ground in one of the chambers.

11. Grinding system according to claim 10, wherein a first level-sensor is provided between the inlet chamber and the grinding chamber and a second level-sensor is included between the inlet chamber and the outlet chamber.

12. Grinding system according to claim 11, wherein the first level-sensor comprises a sensor at the top and at the bottom of the accumulation zone between the inlet chamber and the grinding chamber and the second level-sensor comprises a sensor at the top and at the bottom of the accumulation zone between the grinding chamber and the outlet chamber.

13. Vacuum grinding method for a vacuum grinding system comprising a plurality of elements connected in series, said elements comprising: an inlet chamber adjacent to the inlet of the system, capable of being connected in fluid connection to a vacuum pump; a grinding chamber, arranged downstream of the inlet chamber, capable of being connected in fluid connection to a vacuum pump; and an outlet chamber, downstream of the grinding chamber and adjacent to the outlet of the system, also capable of being connected in fluid connection to a vacuum pump;
the method comprising the steps of:
admitting the material to be ground into the inlet chamber;
after admission of the material to be ground into the inlet chamber, evacuating the inlet chamber;
establishing a fluid connection between the inlet chamber and the grinding chamber to supply the grinding chamber with material to be ground;
after admission of the material to be ground into the grinding chamber, interrupting the fluid connection between the inlet chamber and the grinding chamber;
grinding the material using the grinder;
establishing a fluid connection between the grinding chamber and the outlet chamber to ensure that the ground material passes into the outlet chamber;
interrupting the fluid connection between the grinding chamber and the outlet chamber;
reducing or stopping the air-evacuation of the outlet chamber until the pressure of the outlet chamber reaches a predetermined output threshold;
carrying out the passage of the ground material from the outlet chamber to the outlet of the grinding system.

14. Method according to claim 13,
wherein the grinding system comprises an inlet material flow control valve; and
wherein the material to be ground is admitted into the inlet chamber through the opening of said valve and said valve is closed before evacuating air from the inlet chamber.

15. Method according to claim 13,
wherein the grinding system comprises a valve feeding the grinding chamber; and
wherein the fluid connection between the inlet chamber and the grinding chamber is established by the opening of said valve and interrupted by the closing of said valve.

16. Method according to claim 13,
wherein the grinding system comprises a post-grinding flow control valve; and
wherein the fluid connection between the grinding chamber and the outlet chamber is established by the opening of the said valve and interrupted by the closing of the said valve.

17. Method according to claim 13,
wherein the grinding system comprises an outflow control valve; and
wherein the passage of the ground material from the outlet chamber to the outlet of the grinding system is effected by opening said valve.

18. Grinding method according to claim 17, comprising a preliminary step of closing all the material flow valves and at least partially evacuating each of the chambers of the grinding system before initiating the step of opening the inlet material flow control valve.

19. Method according to claim 13, wherein the grinding step is preceded by a step of metering the quantity of material to be admitted at the grinder.

20. Method according to claim 13, wherein the step of passing the ground material from the outlet chamber to the outlet of the grinding system is preceded by a step of metering the amount of ground material.

21. Method according to claim 13, wherein the steps of the grinding method are repeated so as to provide continuous grinding material.

22. Method according to claim 13, wherein the grinding system comprises a first level-sensor between the inlet chamber and the grinding chamber and wherein the establishing or interrupting of the fluid connection between the inlet chamber and the grinding chamber is controlled by a signaling of the first level-sensor respectively in the presence and in the absence of material.

23. Method according to claim 13, wherein the grinding system comprises a second level-sensor between the grinding chamber and the outlet chamber and wherein the establishing or interrupting of the fluid connection between the grinding chamber and the outlet chamber is controlled by a signaling of the second level-sensor respectively in the presence and in the absence of material.
